(19) United States
(12) Patent Application Publication
(10) Pub. No.: US 2026/0180873 A1
(43) Pub. Date: Jun. 25, 2026

(54) DYNAMIC RADIO BEARER SELECTION ASSOCIATED WITH AI/ML OPERATIONS

(71) Applicant: InterDigital Patent Holdings, Inc., Wilmington, DE (US)

(72) Inventors: Morteza Kheirkhah, London (GB); Oumer Teyeb, Montreal (CA); Tejaswinee Lutchoomun, Montreal (CA); Yugeswar Deenoo Narayanan Thangaraj, Chalfont, PA (US)

(73) Assignee: InterDigital Patent Holdings, Inc., Wilmington, DE (US)

(21) Appl. No.: 19/125,460

(22) PCT Filed: Nov. 2, 2023
(86) PCT No.: PCT/US2023/036649

§ 371 Date: Apr. 29, 2025

Related U.S. Application Data
(60) Provisional application No. 63/421,818, filed on Nov. 2, 2022.

(51) Int. Cl. H04L 41/16; H04L 5/00

(52) U.S. Cl. CPC H04L 41/16; H04L 5/0044

(57) ABSTRACT

A wireless transmit/receive unit (WTRU) may be configured to receive information that indicates: a radio bearer of a first radio bearer type associated with a control plane; a radio bearer of a second radio bearer type associated with a user plane; and a condition associated with sending data associated with an artificial intelligence/machine learning (AI/ML)-related operation. The WTRU may receive an indication to start the AI/ML-related operation. The WTRU may determine that the data associated with the AI/ML-related operation is available. The WTRU may select, based on at least the condition, a radio bearer type, from the first radio bearer type and the second radio bearer type, to use to send the data. The WTRU may send at least a portion of the data via a radio bearer of the selected radio bearer type.

### CROSS-REFERENCE TO RELATED APPLICATIONS

This application claims the benefit of U.S. Provisional Patent Application No. 63/421,818, filed Nov. 2, 2022, the contents of which are hereby incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein related to dynamic radio bearer selection for artificial intelligence/machine learning (AI/ML) operations.

In examples, a WTRU may include a processor configured to perform one or more actions. For example, the WTRU may perform AI/ML training or data collection for AI/ML training. The WTRU may receive information that indicates: a first radio bearer configuration that indicates a radio bearer of a first radio bearer type associated with a control plane; a second radio bearer configuration that indicates a radio bearer of a second radio bearer type associated with a user plane; a condition associated with sending data associated with an artificial intelligence/machine learning (AI/ML)-related operation; a first association between the condition and the first radio bearer type; and a second association between the condition and the second radio bearer type. The WTRU may receive an indication to start the AI/ML-related operation. The WTRU may determine that the data associated with the AI/ML-related operation is available. The WTRU may select, based on at least the condition, a radio bearer type, from the first radio bearer type and the second radio bearer type, to use to send the data. The WTRU may send at least a portion of the data via a radio bearer of the selected radio bearer type.

The first radio bearer type may be a signaling radio bearer (SRB). The second radio bearer type may be a data radio bearer (DRB). The WTRU may receive an indication of a time to start training an AI model and a deadline by which to send the data. The data may indicate at least one of: that the AI model is trained or a parameter associated with the training. At the time to start training the AI model, the WTRU may perform AI training. The at least a portion of the data may be sent in accordance with the deadline threshold.

The AI/ML-related operation may involve training an AI/ML model. The WTRU may receive an indication of a time to start training the AI/ML model and a deadline by which to send the data. The data may indicate at least one of: that the AI/ML model is trained or a parameter associated with the training. The WTRU may determine a first estimated send time of the data based on the first association and a second estimated send time of the data based on the second association. Selecting, based on at least the condition, the radio bearer type, from the first radio bearer type and the second radio bearer type, to use to send the data may comprise selecting the radio bearer type based on whether one or more of the first estimated send time or the second estimated send time satisfies a deadline threshold; and at the time to start training the AI/ML model, perform AI/ML training. The at least a portion of the data may be sent in accordance with the deadline threshold.

The AI/ML-related operation may comprise collecting the data. Sending at least a portion of the data via a radio bearer of the selected radio bearer type may comprise sending the data to a network entity for training an AI/ML model.

The WTRU may select the radio bearer of the selected radio bearer type, from a first and a second radio bearer of the selected radio bearer type, based on an uplink buffer level. The WTRU may select the first radio bearer if a total uplink buffer level of the first radio bearer and the second radio bearer is above a threshold. The WTRU may select the second radio bearer if the total uplink buffer level of the first radio bearer and the second radio bearer is below the threshold. The WTRU may select the first radio bearer if an uplink buffer level of the first radio bearer is below an uplink buffer level of the second radio bearer. The WTRU may select the second radio bearer if the uplink buffer level of the second radio bearer is below the uplink buffer level of the first radio bearer.

The WTRU may select, as the radio bearer of the selected radio bearer type, a first radio bearer of the selected radio bearer type if a radio condition of a serving cell is above a threshold. The WTRU may select, as the radio bearer of the selected radio bearer type, a second radio bearer of the selected radio bearer type if the radio condition of the serving cell is below the threshold.

The WTRU may select the radio bearer of the selected radio bearer type, from a first and a second radio bearer of the selected radio bearer type, based on a payload of the data. The WTRU may select the first radio bearer if a payload size of the data is above a threshold. The WTRU may select the second radio bearer if the payload size of the data is below the threshold. The WTRU may select the first radio bearer if a type of the payload of the data is a first payload type. The WTRU may select the second radio bearer if the type of the payload of the data is a second payload type.

The WTRU may select, as the radio bearer of the selected radio bearer type, a first radio bearer of the selected radio bearer type if a reliability or security standard of the data is above a threshold. The WTRU may select, as the radio bearer of the selected radio bearer type, a second radio bearer of the selected radio bearer type if the reliability or security standard of the data is below the threshold.

The radio bearer of the selected radio bearer type may be a first radio bearer of the selected radio bearer type. The at least a portion of the data may be a first portion of the data. The WTRU may select a second radio bearer of the selected radio bearer type. The WTRU may send with a second portion of the data via the second radio bearer of the selected radio bearer type.

The WTRU may determine, based on a transmission parameter, a radio bearer on which to send data associated with the AI/ML training. The WTRU may send the data on the determined radio bearer.

The WTRU may receive configuration information associated with training an AI/ML model. An indication of when to start training the AI/ML model may be received. The WTRU may receive an indication of a deadline by which to send the data. The data may be indicative of a trained AI/ML model or metadata associated with the training. The data may be sent in accordance with the deadline.

The transmission parameter may include one or more of: an amount of time remaining before the deadline, current radio conditions between the WTRU and a serving cell, an amount of data to be sent, security requirements of the data, or current uplink buffer levels.

### BRIEF DESCRIPTION OF THE DRAWINGS

Furthermore, like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example a high-level federated learning interaction between participants and the central AI server.

FIG. 3 illustrates an example functional relation between multiple agents and multiple collecting devices.

FIG. 4 illustrates an example input data disturbance scenario.

FIG. 5 is an example call flow illustrating a WTRU selecting/determining whether to use the control plan or the user plane, and over which radio bearers to send data.

FIG. 6 illustrates an example timeline for data transmission.

FIG. 7 is an example call flow illustrating a WTRU selecting/determining a radio bearer over which to send data.

### DETAILED DESCRIPTION

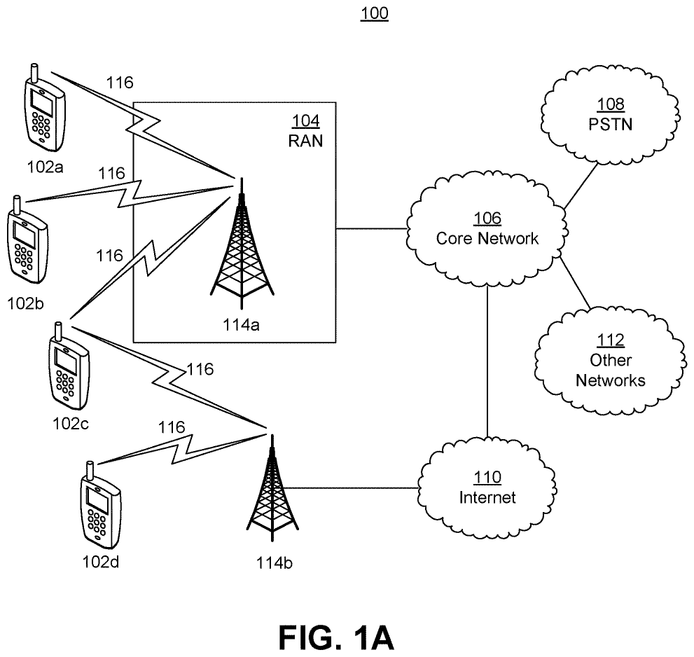

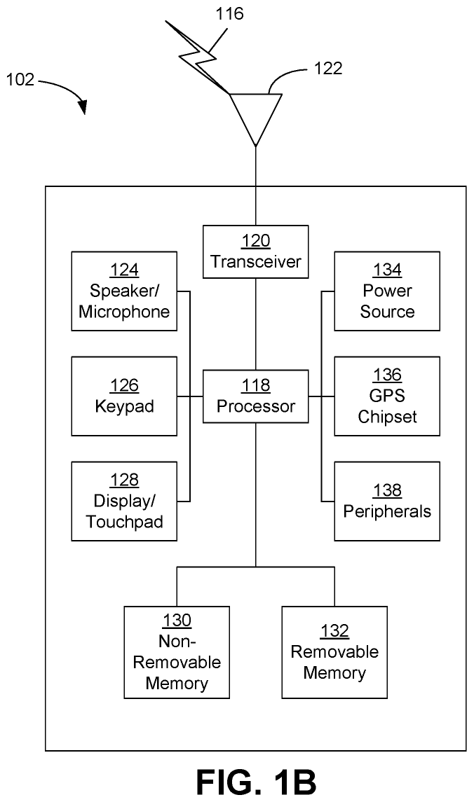

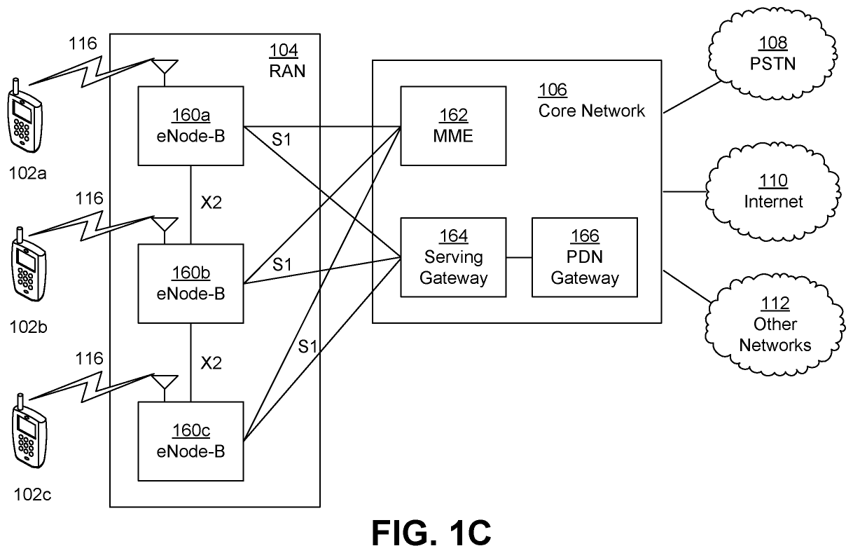

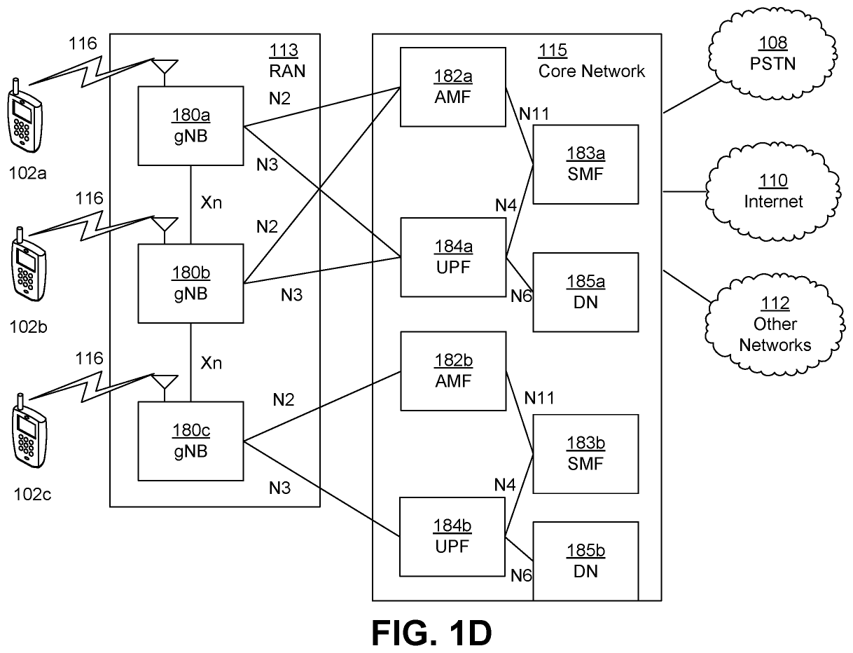

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to dynamic radio bearer selection for artificial intelligence/machine learning (AI/ML) operations.

Systems, methods, and instrumentalities are described herein related to dynamic radio bearer selection for artificial intelligence/machine learning (AI/ML) operations.

In examples, a WTRU may include a processor configured to perform one or more actions. For example, the WTRU may perform AI/ML training or data collection for AI/ML training. The WTRU may receive information that indicates: a first radio bearer configuration that indicates a radio bearer of a first radio bearer type associated with a control plane; a second radio bearer configuration that indicates a radio bearer of a second radio bearer type associated with a user plane; a condition associated with sending data associated with an artificial intelligence/machine learning (AI/ML)-related operation; a first association between the condition and the first radio bearer type; and a second association between the condition and the second radio bearer type. The WTRU may receive an indication to start the AI/ML-related operation. The WTRU may determine that the data associated with the AI/ML-related operation is available. The WTRU may select, based on at least the condition, a radio bearer type, from the first radio bearer type and the second radio bearer type, to use to send the data. The WTRU may send at least a portion of the data via a radio bearer of the selected radio bearer type.

The first radio bearer type may be a signaling radio bearer (SRB). The second radio bearer type may be a data radio bearer (DRB). The WTRU may receive an indication of a time to start training an AI model and a deadline by which to send the data. The data may indicate at least one of: that the AI model is trained or a parameter associated with the training. At the time to start training the AI model, the WTRU may perform AI training. The at least a portion of the data may be sent in accordance with the deadline threshold.

The AI/ML-related operation may involve training an AI/ML model. The WTRU may receive an indication of a time to start training the AI/ML model and a deadline by which to send the data. The data may indicate at least one of: that the AI/ML model is trained or a parameter associated with the training. The WTRU may determine a first estimated send time of the data based on the first association and a second estimated send time of the data based on the second association. Selecting, based on at least the condition, the radio bearer type, from the first radio bearer type and the second radio bearer type, to use to send the data may comprise selecting the radio bearer type based on whether one or more of the first estimated send time or the second estimated send time satisfies a deadline threshold; and at the time to start training the AI/ML model, perform AI/ML training. The at least a portion of the data may be sent in accordance with the deadline threshold.

The AI/ML-related operation may comprise collecting the data. Sending at least a portion of the data via a radio bearer of the selected radio bearer type may comprise sending the data to a network entity for training an AI/ML model.

The WTRU may select the radio bearer of the selected radio bearer type, from a first and a second radio bearer of the selected radio bearer type, based on an uplink buffer level. The WTRU may select the first radio bearer if a total uplink buffer level of the first radio bearer and the second radio bearer is above a threshold. The WTRU may select the second radio bearer if the total uplink buffer level of the first radio bearer and the second radio bearer is below the threshold. The WTRU may select the first radio bearer if an uplink buffer level of the first radio bearer is below an uplink buffer level of the second radio bearer. The WTRU may select the second radio bearer if the uplink buffer level of the second radio bearer is below the uplink buffer level of the first radio bearer.

The WTRU may select, as the radio bearer of the selected radio bearer type, a first radio bearer of the selected radio bearer type if a radio condition of a serving cell is above a threshold. The WTRU may select, as the radio bearer of the selected radio bearer type, a second radio bearer of the selected radio bearer type if the radio condition of the serving cell is below the threshold.

The WTRU may select the radio bearer of the selected radio bearer type, from a first and a second radio bearer of the selected radio bearer type, based on a payload of the data. The WTRU may select the first radio bearer if a payload size of the data is above a threshold. The WTRU may select the second radio bearer if the payload size of the data is below the threshold. The WTRU may select the first radio bearer if a type of the payload of the data is a first payload type. The WTRU may select the second radio bearer if the type of the payload of the data is a second payload type.

The WTRU may select, as the radio bearer of the selected radio bearer type, a first radio bearer of the selected radio bearer type if a reliability or security standard of the data is above a threshold. The WTRU may select, as the radio bearer of the selected radio bearer type, a second radio bearer of the selected radio bearer type if the reliability or security standard of the data is below the threshold.

The radio bearer of the selected radio bearer type may be a first radio bearer of the selected radio bearer type. The at least a portion of the data may be a first portion of the data. The WTRU may select a second radio bearer of the selected radio bearer type. The WTRU may send with a second portion of the data via the second radio bearer of the selected radio bearer type.

The WTRU may determine, based on a transmission parameter, a radio bearer on which to send data associated with the AI/ML training. The WTRU may send the data on the determined radio bearer.

The WTRU may receive configuration information associated with training an AI/ML model. An indication of when to start training the AI/ML model may be received. The WTRU may receive an indication of a deadline by which to send the data. The data may be indicative of a trained AI/ML model or metadata associated with the training. The data may be sent in accordance with the deadline.

The transmission parameter may include one or more of: an amount of time remaining before the deadline, current radio conditions between the WTRU and a serving cell, an amount of data to be sent, security requirements of the data, or current uplink buffer levels.

Example artificial intelligence/machine learning (AI/ML) services (e.g., in 5G systems) are provided herein. Wireless transmit/receive units (WTRUs) may interact with network functions (NFs) in the 5G core (5GC) network (e.g., AI/ML function (AIMLF) or federated learning function (FLF)). WTRUs may interact with an application server (AS) and/or an application function (AF) through the user plane (UP) (e.g., via user plane function (UPF)) or control plane (CP) (e.g., via non-access stratum (NAS) signaling). In the case of the UP model, the WTRU may interact with (e.g., at least interact with) the AS and/or AF over a data radio bearer (DRB). The DRB may be established between the WTRU and a next generation radio access network (NG-RAN) over the Uu air interface. In the CP model, the WTRU may use a signaling radio bearer (SRB) to carry NAS or radio resource control (RRC) messages.

Example AI/ML metadata and operations are provided herein. AI/ML metadata may include model topology, model weights, training completion time window, and/or other AI/ML specific parameters (e.g., such as loss function, entropy, prediction accuracy, etc.). The AI/ML operations may be categorized as following: (i) model distribution; (ii) model splitting between AI/ML endpoints; and (iii) federated learning.

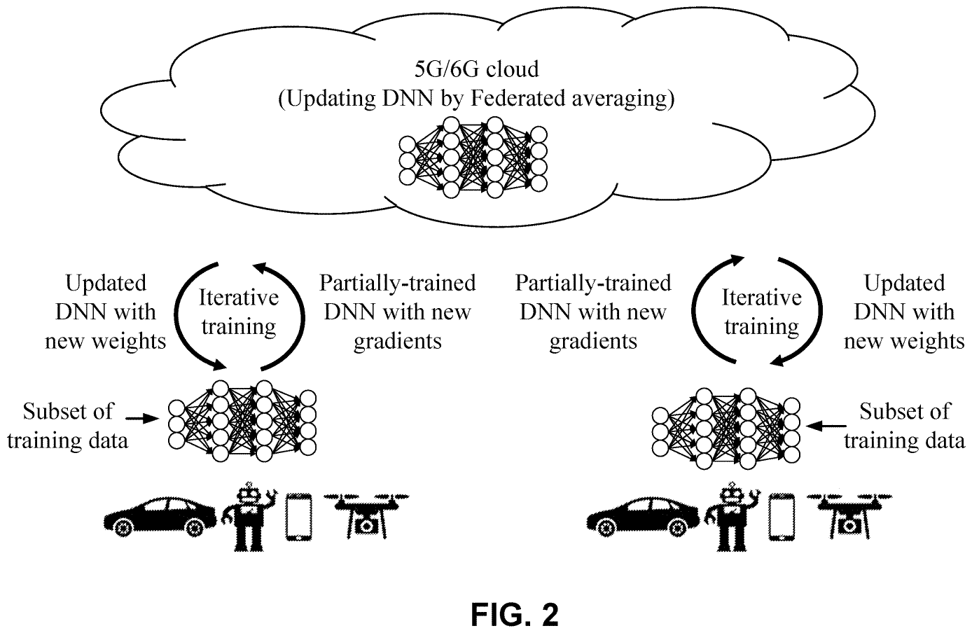

Example federated learning (FL) may be provided. In FL mode, the central AI server may train a global model. For example, the AI server may train the global model by combining local models trained by each participant (e.g., WTRU) based on a model averaging technique. The WTRU may perform local model training within each training cycle (e.g., based on a model downloaded from the centralized AI server using local data). The WTRU may (e.g., once the local model training is complete) deliver the training results (e.g., a gradient for a deep neural network (DNN)) to the centralized AI server (e.g., via 5G uplink channels). The centralized AI server may aggregate the gradients (e.g., model weights) from the WTRUs. The centralized AI server may update the global model (e.g., using the aggregated gradients). Another training cycle (e.g., the next training cycle) may begin. For example, the AI server may distribute the updated global model to WTRUs (e.g., via 5G downlink channels). FIG. 2 illustrates a high-level FL interaction between participants (e.g., WTRUs) and the central AI server over the 5G system.

FL training over wireless communication may be different than FL training in data centers (e.g., where participants, such as WTRUs, may have highly variable conditions in terms of available computational and network resources). The WTRUs may not be homogeneous. The WTRUs may have different capabilities (e.g., in terms of their computation resources, network resources, and/or supported ML framework). It may not be efficient for a centralized AI server to include all participants (e.g., WTRUs) in a training session. A member selection mechanism may be used (e.g., before each training cycle begins). If the conditions (e.g., a device's computation resource(s) and/or wireless channel condition) are not changed, the WTRU re-selection and training (re-)configurations may not be performed for each training cycle. Different WTRUs may be (re-)selected over time (e.g., to achieve global training with diverse datasets).

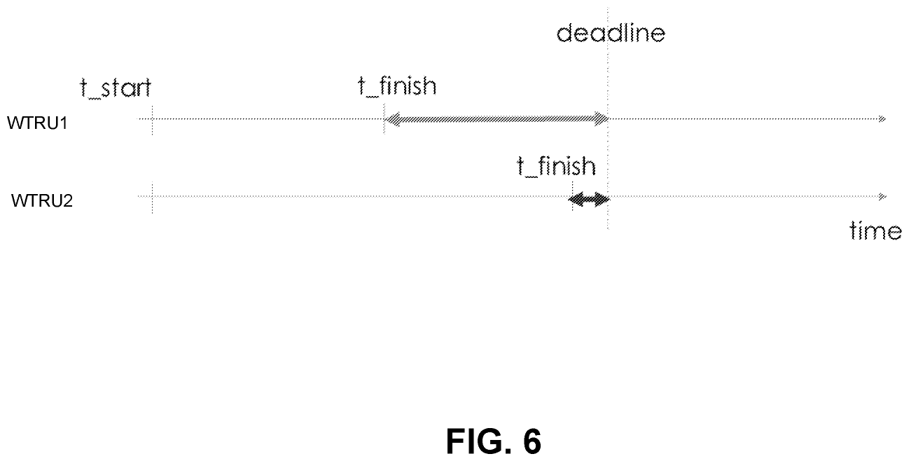

Feature(s) associated with synchronous FL (SFL) are provided herein. SFL may be referred to as a variant of FL. The SFL may have a latency budget (e.g., all participants finish uploading their respective training results within a predefined time window, for example, as shown in FIG. 6). For example, all WTRUs participating in a training session may finish uploading their respective training results within a predefined latency budget. For example, for uncompressed FL for image recognition, an uplink transmission deadline may be between roughly 1 to 3 seconds, as illustrated in Table 1.

TABLE 1
Latency and user experienced uplink and downlink
(UL/DL) data rates for uncompressed FL

| Mini-batch | GPU | Maximum latency for | | User experienced UL/DL data rate | |
|---|---|---|---|---|---|
| size | computation | trained gradient uploading | | for trained gradient uploading and | |
| (images) | time (ms) | and global model distribution | | global model distribution | |
| 64 | 325 | 3.24 | s | 325 | Mbit/s |
| 32 | 191 | 1.9 | s | 55 | Mbit/s |
| 16 | 131 | 1.3 | s | 810 | Mbit/s |
| 8 | 111 | 1.1 | s | 960 | Mbit/s |
| 4 | 105 | 1.04 | s | 1.0 | Gbit/s |

Example multi-agent multi-device ML operations are provided herein. Multi-agent multi-device ML operations with a large data size may be used if there is a level of disturbance for data collection and/or transfer (e.g., shortage of network and/or computational resources, temporary failure, etc.).

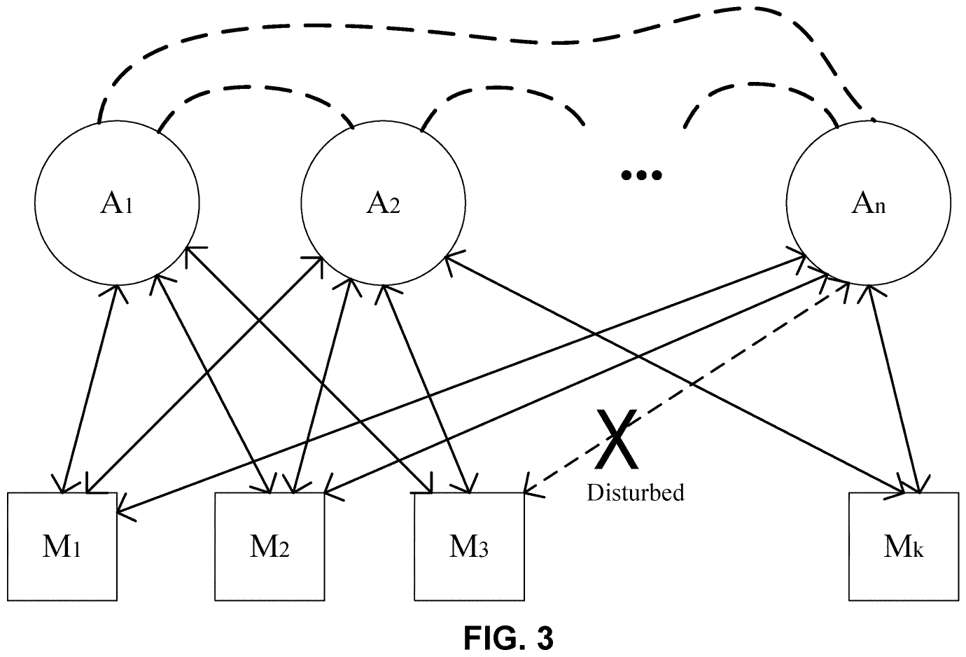

FIG. 3 illustrates an example functional relation between multiple agents (denoted A1 . . . An) and multiple collecting devices (e.g., WTRUs, denoted M1 . . . Mk). The devices may perform ML operations. For example, functional splitting may be possible between a device and one or more learning agents. An agent (e.g., each agent) may interact with a set of WTRUs and/or other agents (e.g., collaboratively). For example, the devices and agents may partition and/or aggregate workflow (e.g., in a manner similar to that used in data center networks).

In some examples, if the expected input data of a device (e.g., which may be raw data or/and trained data) is not delivered to the intended learning agent in time, the input data may not be used by the learning agent. This may cause the resources of the parties involved to be wasted. There may be several reasons that the input data is not delivered in time (e.g., is disturbed). For example, the input data may not be delivered on time due to a lack of network resources (e.g., radio resources due to temporal degradation, higher noise/interference level, highly crowded situations, partial/total break-down, etc.).

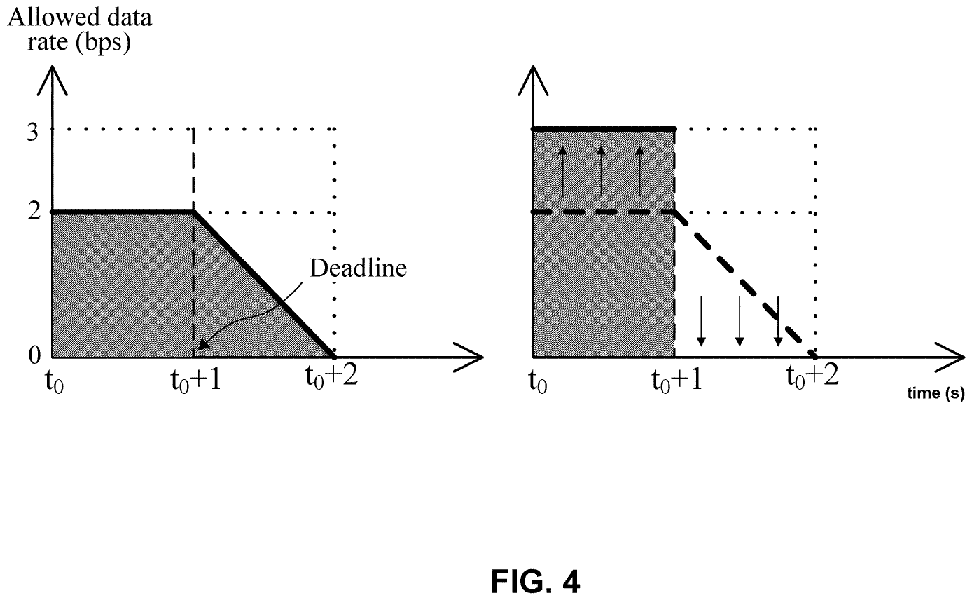

FIG. 4 illustrates an example input data disturbance scenario (e.g., in which the WTRU may take one or more action(s) to proactively mitigate the potential disturbances). In an example, the deadline (e.g., preferred deadline) for input data transfer may be 1 second (e.g., t=t0+1) with 3 bits of input data (e.g., useful input data). For example, two different kinds of scheduling may be given. For example, a first kind of scheduling may be referred to as imperfect scheduling. A second kind of scheduling may be referred to as good (e.g., or perfect) scheduling. A bit of data (e.g., each bit of data) sent may take one second.

The transfer payload type may not be limited to input data for learning agent(s). For example, the payload type may include a learning model transfer. The transfer direction may be uplink (e.g., for input data transfer) or downlink (e.g., for model distribution/transfer). In an example with imperfect scheduling, the input data may miss a deadline (e.g., because the input data is delivered to a destination at a time t0+2, for example, due to not allocating a higher data rate to this uplink data transmission). In an example with perfect scheduling, the input data may be delivered to a destination within the predefined deadline (e.g., 1 second). In an example with perfect scheduling, the network resources may be assigned to other devices (e.g., other WTRUs) during time t0+1 and/or t0+2. This may provide an efficient use of radio resources.

Feature(s) associated with RRC protocol, signaling radio bearers (SRBs), and/or NAS signaling are provided herein. The RRC protocol may be a control plane (CP) protocol. The RRC protocol may control a connection between a WTRU and the network (e.g., a network entity such as a base station/gNodeB (gNB)).

Some example functions of the RRC protocol may include: broadcast of system information (e.g., for cell discovery, cell selection/re-selection, common channel configurations, etc.); RRC connection control (e.g., connection setup from IDLE state, connection resume from INACTIVE state, paging of IDLE/INACTIVE UEs, radio bearer configuration, handover, management of carrier aggregation and/or dual connectivity, recovery from radio link failure, etc.); and/or measurement configuration and/or reporting.

A WTRU may communicate with the core network (CN) using the NAS protocol. NAS messages may be carried within a transparent container within an RRC message (e.g., the RRC protocol may see the NAS information as a stream of bits and may not understand the information included therein).

NAS and RRC messages may be transported between the WTRU and the network via SRBs. In some examples (e.g., in new radio (NR) communications), there may be five types of SRBs available. For example, SRB0 may be used for RRC messages such RRC Setup Request, RRC Resume Request, RRC Reestablishment request, etc. (e.g., where no security context is established at the WTRU, and integrity protection and encryption cannot be used or are not required). Other SRBs (e.g., all other SRBs) may be integrity protected and/or encrypted. For example, SRB1 may be used for RRC messages (e.g., which may include a piggybacked NAS message) and/or for NAS messages (e.g., prior to the establishment of SRB2). SRB1 may be the main SRB (e.g., since it is used to transport higher priority RRC messages).

SRB2 may have a lower priority than SRB1. SRB2 may be configured by the network after security activation. SRB2 may be used for NAS messages and/or sending WTRU information response(s) on request from the network (e.g., for sending mobility history, logged measurements, etc., that are not high priority). SRB3 may be used for direct CP communication with a secondary node (e.g., if the WTRU is in a dual connectivity mode) (e.g., sending measurements reports for measurement configured by the secondary node). SRB4 may be used for sending application layer measurement for quality of experience (QoE) monitoring (e.g., buffering for streaming services). SRB4 may support message segmentation (e.g., since QoE measurement report can be relatively large). For example, a QoE measurement report may be segmented into (e.g., up to) 16 RRC packets. In the uplink, WTRU capability information (e.g., apart from the QoE report) may be relatively large. The WTRU capability information may be segmented into several RRC packets. The WTRU capability information may be sent via SRB1.

SRB1 may have the highest priority (e.g., priority 1) among all radio bearers (e.g., since SRB1 may be used for messages such as RRC control messages). SRB3 may have a similar priority as SRB1. The SRB3 priority may be relevant (e.g., only relevant) for the case of dual connectivity. The SRB3 priority may impact scheduling on the secondary link (e.g., only on the secondary link).

SRB2 may be assigned a second highest priority (e.g., priority 2). SRB4 and/or DRBs may have a third highest priority. For example, SRB4 and/or DRBs may be (e.g., each be) assigned a priority as low as priority level 16. The priority level may determine the priority of the data from the DRB and/or SRB (e.g., at the MAC level of the WTRU). The WTRU may try to make use of uplink grants received from the network. For example, data from a higher priority SRB and/or DRB may be prioritized over data from a lower priority SRB and/or DRB (e.g., if the WTRU is not granted enough resources to send all SRBs and/or DRBs).

During an FL training cycle, a participant (e.g., a WTRU) may train a local neural network (NN) model (e.g., in the WTRU's environment or based on a dataset). The training process may take a certain amount of time to complete (e.g., as shown in FIG. 6). The training process may get delayed depending on several factors. The factors may include the resource availability of the WTRU (e.g., computational resources such a graphics processing unit/central processing unit (GPU/CPU), battery, etc.). An FL training session may involve a task completion deadline. For example, the WTRU may deliver its local training to the AF/AS within a particular time window (e.g., as shown in FIG. 6). In some examples (e.g., if the local training result is delivered after the deadline), the local training result may not be included in the next version of the global trained model or the local training result may be discarded. The group performance of an AI/ML service may be dictated by the worst performer (e.g., the WTRU with the worst performance). For example (e.g., in SFL) information and function availability of the federation may suffer if the performance of individual components falls significantly behind that of other components (e.g., since it may be ideal for the entire group to complete the iteration). This may be referred to as the flocking problem.

There may be several reasons a WTRU participating in an FL training session may miss the task completion deadline or suffer from the flocking problem. Such reasons may include, for example, a lack of proper scheduling for the uplink transmission of data related to the training. The lack of proper scheduling may be due to one or more of the following: blocking/delay due to data that have higher priority than the AI/ML flow; bad radio conditions (e.g., between the WTRU and serving base station/cell); overloading at the serving base station/cell (e.g., several WTRUs connected to the same cell or/and the WTRUs being served by the cell have active applications/services that have heavy traffic demands); and/or the like.

Another reason that a WTRU participating in an FL training session may miss the task completion deadline or suffer from the flocking problem may be a lack of sufficient computational resources (e.g., such as CPU/GPU). The lack of resources may cause a delay (e.g., a significant delay) in completing the training of an NN model. This delay may be compensated for by allocating more resources to the network (e.g., at uplink and/or CN).

It may be desirable for WTRUs to ensure that the (meta)data needed for the AI/ML operations (e.g., training) are sent on time and do not miss their task completion deadline and/or that the flocking scenarios are prevented. The network may not know the situation that the WTRU or the network will be in by the time AI/ML-related data is available. The network may not be able to configure a (e.g., single) DRB/SRB to send the AI/ML-related data without overprovisioning and possibly harming other traffic. For example, if a WTRU is configured to send the AI/ML-related data using the highest priority DRB, and the AI/ML data becomes ready well ahead of the deadline, sending the data with a high priority data may block other traffic with more strict latency demands at that point in time.

Another aspect (e.g., in addition to data priority) is where the termination point is for the AI/ML-related data. For example, the FL controller may reside in the gNB, UPF, access and mobility management function (AMF), or any other network node. For some cases, it may be appropriate to send the data via the control plane (e.g., RRC message, NAS message embedded within an RRC message). For some cases (e.g., other cases), it may be more suitable to send the data via the user plane (e.g., using a DRB).

Radio bearers may be categorized into two groups: data radio bearers (DRB) (e.g., for user plane data) and signaling radio bearers (SRB) (e.g., for control plane data). For AI/ML, there may be a large variation in the size of messages (e.g., training (meta)data, data set for training, etc.), from very small messages (e.g., binary one bit for indicating whether a WTRU is AI/ML capable) to very large messages (e.g., weights of the neural network, radio conditions/WTRU configuration parameters under which neural network was trained, for example, channel coherence time, channel coherence bandwidth, signal-to-noise ratio (SNR), signal-to-interference noise ratio (SINR), bandwidth part (BWP), WTRU antenna configuration, etc.). As a result, the mechanism by which SRB1 is dedicated to RRC signaling messages, SRB2 for dedicated NAS messages, DRB for transmission of data plane packets, etc., may not be appropriate for AI/ML traffic.

A WTRU may determine the right mechanism (e.g., CP or UP) to send AI/ML related data, and/or the specific SRB or DRB to be used, that will ensure the AI/ML related data is received at the network before a certain deadline (e.g., the latest time for the data to be integrated in an FL training, for example, as shown in FIG. 6), without harming the performance of other traffic from the concerned WTRUs (e.g., including the transmitting WTRU) and other WTRUs.

A WTRU may be connected to a public land mobile network (PLMN) via an access network (e.g., gNB). The WTRU may have gone through a registration process. The WTRU may have an established PDU session between the WTRU and the network (AMF) for an application client running at the WTRU. 5GC may support data and analytics exposure to the WTRU and application server (AS) via the user plane (UP) and control plane (CP). This support may be activated for a WTRU during a PDU session establishment or modification procedure. The AS/AF may activate such supports by interacting with (e.g., directly interacting with) 5GC. The AS may expose information to the WTRU via 5GC via the CP and/or the UP. NG-RAN may support data and analytics exposure to AS/AF via 5GC. The AS/AF may be able to subscribe or request data and/or analytics from 5GC and NG-RAN. 5GC may employ a dedicated network function for handling AI/ML workflows such as FL.

Although examples described herein may relate to AI/ML metadata (e.g., trained model) or an AI/ML-related data set, feature(s) described herein may be applicable to other uplink data (e.g., uplink traffic) that may have varying needs and/or a varying and/or bursty nature. An example of such data/traffic may be extended reality (XR) traffic, (e.g., traffic related to augmented reality (AR), virtual reality (VR), mixed reality (MR), etc.), where the network may not be able to configure a proper bearer, logical channel identifier (LCID), and/or the like (e.g., that can be used to transmit the data) without over-provisioning (e.g., configuring a bearer and/or LCID with the highest priority, highest data rate, lowest packet delay budget, etc.).

As used herein, the word “file” may be used interchangeably with the word “payload.” A file (e.g., payload) may, for example, include data in an uplink buffer of a WTRU. A “file size” (e.g., a payload size) may refer to the amount of data in the WTRU's uplink buffer. A “file type” (e.g., a payload type) may refer to the type of data in the WTRU's uplink buffer. As used herein, the term “application function” or “AF” may be used interchangeably with the term “application server” or “AS.”

As used herein, the term “AI/ML server” may refer to an entity and/or function in a network that is responsible for managing the AI/ML life cycle management (LCM). For example, an AI/ML server may perform LCM functions such as controlling and/or configuring federated learning (FL) operations.

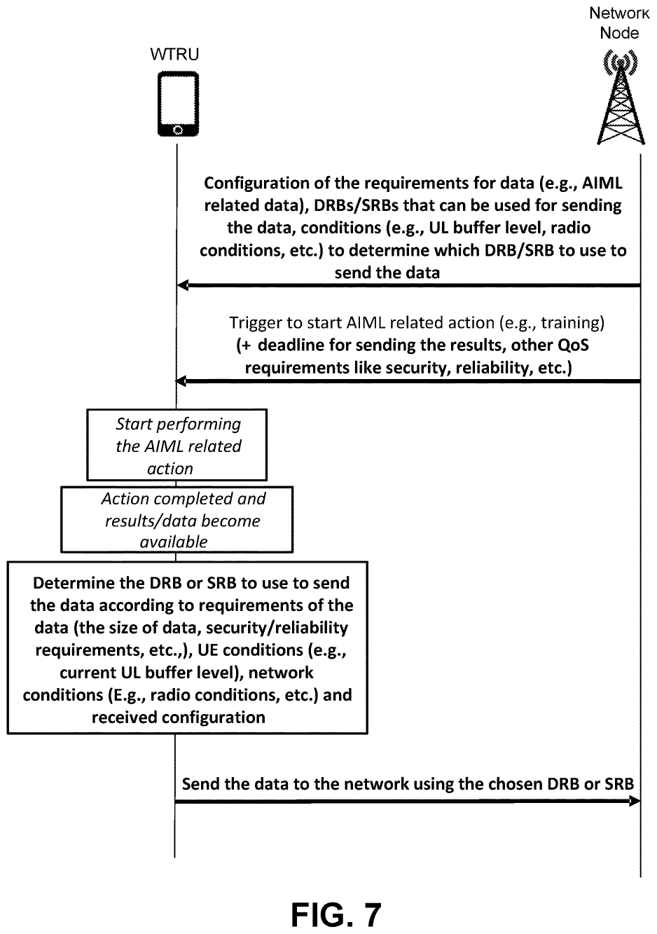

A WTRU may receive information (e.g., a configuration) from the network about a condition associated with sending data associated with an AI/ML-related operation (e.g., training a model or data collection). For example, the information may relate to training an AI/ML model (e.g., as shown in FIG. 7). The WTRU may receive an indication from the network of when to start the training (e.g., as shown in FIG. 7). The WTRU may receive an indication to collect data associated with training an AI/ML model. The WTRU may receive an indication from the network regarding the deadline (e.g., deadline threshold) by which to send data associated with the AI/ML training (e.g., as shown in FIG. 7). The data may indicate that the AI model is trained or a parameter associated with the training (e.g., the trained AI/ML model or metadata associated with the training). The WTRU may start performing the AI/ML model training (e.g., at the time to start training, as shown in FIGS. 6 and 7). The data may be sent in accordance with the deadline. The data may be used by a network entity to train an AI/ML model.

The WTRU may determine a radio bearer type and/or a radio bearer of the selected radio bearer type (e.g., a particular SRB or DRB of the selected radio bearer type) to use to send the data based on one or more transmission parameters. The WTRU may make the determination when the AI/ML model training is completed or soon to be completed. The transmission parameter(s) may include one or more of the following: an amount of time remaining before a deadline (e.g., by which to send the data), current radio conditions between the WTRU and a serving cell, an amount of data to be sent, security requirements of the data, and/or current uplink buffer levels. The WTRU may send the data via the chosen radio bearer. The data may be sent in accordance with the deadline.

A WTRU may determine a radio bearer to use to send AI/ML-related data (e.g., as shown in FIG. 7). For example, the WTRU may receive information (e.g., first and second radio bearer configurations) that indicates a first radio bearer type and a second radio bearer type. The first radio bearer type may be associated with a control plane and the second radio bearer type may be associated with a user plane. The information may indicate for the WTRU to send data. The information may indicate a condition associated with the data, a first association between the condition and the first radio bearer type, and/or a second association between the condition and the second radio bearer type.

The WTRU may determine an estimated send time of the data based on the condition (e.g., satisfaction of the condition) and at least one of the first radio bearer type or the second radio bearer type. For example, the first radio bearer type may be an SRB and the second radio bearer type may be a DRB. The WTRU may determine the radio bearer type to use based on the condition (e.g., an AI/ML task completion deadline, for example, as shown in FIG. 7). The WTRU may select a radio bearer type, from the first radio bearer type and the second radio bearer type, based on at least the condition (e.g., a condition that the estimated send time satisfies a deadline threshold). The WTRU may determine a radio bearer to use to transmit AI/ML training results (e.g., as shown in FIG. 7). The WTRU may send at least a portion of the data via a radio bearer of the selected radio bearer type.

The WTRU may determine the radio bearer to use based on an amount of time left (e.g., until a deadline) to send the training data. For example, the WTRU may be configured to perform one or more of the following: use a first signaling radio bearer (SRB) (e.g., SRB1) if the amount of time left is below a first threshold (e.g., threshold1); use a second SRB (e.g., SRB2) if the amount of time left is between the first threshold and a second threshold (e.g., threshold2); use a third SRB (e.g., SRB4) if the amount of time left is between the second threshold and a third threshold (e.g., threshold3); use a first data radio bearer (DRB) (e.g., DRBx) if the amount of time left is between the third threshold and a fourth threshold (e.g., threshold4); use a second DRB (e.g., DRBy) if the amount of time left is between the fourth threshold and a fifth threshold (e.g., threshold5); use a third DRB (e.g., DRBz) if the amount of time left is above a sixth threshold (e.g., threshold6); and/or the like.

A WTRU may use an SRB to deliver data to a network entity (e.g., gNB) with high priority. It may be desirable to deliver data over the control plane (e.g., 5G control plane) in a manner that prevents congestion (e.g., within the 5GC control plane). In an example, the network entity may subscribe to get network analytics. For example, the network analytics may include network analytics regarding the level of congestion within the 5GC control plane. The network entity may determine how to transmit the data from the WTRU to the AI/ML server (e.g., either via CP or via UP through UPF).

A WTRU may decide a radio bearer to use to send AI/ML-related data based on an uplink buffer status. One or more of the following may apply.

A WTRU may consider the uplink buffer status (e.g., total uplink buffer level, uplink buffer level of a certain DRB or SRB, etc.) to determine the radio bearer to use for sending AI/ML training results. The WTRU may be configured to use one or more SRBs if the total uplink buffer level is above a threshold. The WTRU may be configured to use one or more DRBs if the total uplink buffer level is below a threshold.

For example, the WTRU may select the first radio bearer if a total uplink buffer level of the first radio bearer and the second radio bearer is above a threshold. The WTRU may select the second radio bearer if the total uplink buffer level of the first radio bearer and the second radio bearer is below the threshold.

The WTRU may be configured with several uplink buffer thresholds. For example, the uplink buffer thresholds may be associated with different SRBs to be used for sending the AI/ML-related data. For example, the WTRU may be configured to perform one or more of the following: use a first SRB (e.g., SRB1) if the total uplink buffer level is above a first threshold (e.g., threshold1); use a second SRB (e.g., SRB2) if the total uplink buffer level is between a second threshold (e.g., threshold2) and the first threshold; use a third SRB (e.g., SRB4) if the total uplink buffer level is between a third threshold (e.g., threshold3) and the second threshold; use a fourth SRB (e.g., SRBx) if the total uplink buffer level is between a fourth threshold (e.g., thresholdy) and a fifth threshold (e.g., thresholdz); and/or the like.

The WTRU may be configured with several uplink buffer thresholds. For example, the uplink buffer thresholds may be associated with different DRBs to be used for sending the AI/ML related data.

The WTRU may select a first radio bearer if an uplink buffer level of the first radio bearer is below an uplink buffer level of the second radio bearer. The WTRU may select a second radio bearer if the uplink buffer level of the second radio bearer is below the uplink buffer level of the first radio bearer. For example, the WTRU may be configured to perform one or more of the following: use a first DRB (e.g., DRB1) if the total uplink buffer level is below a first threshold (e.g., threshold1); use a second DRB (e.g., DRB2) if the total uplink buffer level is between the first threshold and a second threshold (e.g., threshold2); use a third DRB (e.g., DRBx) if the total uplink buffer level is between a third threshold (e.g., thresholdy) and a fourth threshold (e.g., thresholdz); and/or the like.

The WTRU may be configured to use a certain SRB or DRB for sending an AI/ML-related data. For example, the WTRU may be configured to use a certain SRB or DRB for sending AI/ML-related data if (e.g., only if) the amount of pending uplink data of that bearer is below a certain (e.g., configured) threshold. If the amount of uplink buffered data on that bearer is above the threshold, the WTRU may choose another SRB or DRB to send the data. For example, the determination may be based on: the SRB and/or DRB with the least amount of uplink buffered data; the SRB and/or DRB with the highest priority; or a combination thereof.

The WTRU may be configured to use a certain SRB or DRB for sending AI/ML-related data depending on the number of active bearers. For example, if the number of active bearers is above a certain value, the WTRU may be configured to use SRB(s) (e.g., only SRBs).

A WTRU may determine a radio bearer to use to send the AI/ML-related data based on radio conditions. The WTRU may consider the radio conditions with the current serving cell (e.g., SINR, reference signal received power (RSRP), etc.). For example, the WTRU may use the radio conditions with the current serving cell to determine the radio bearer to be used for sending AI/ML-related data.

For example, the WTRU may select, as the radio bearer (e.g., of a selected radio bearer type), a first radio bearer (e.g., of the selected radio bearer type) if a radio condition of a serving cell is above a threshold. The WTRU may select, as the radio bearer, a second radio bearer (e.g., of the selected radio bearer type) if the radio condition of the serving cell is below the threshold. For example, if the signal level is above a certain threshold, the WTRU may use a low priority DRB to send the AI/ML-related data. For example, if the signal level is below a certain threshold, the WTRU may use a high priority DRB or SRB to send the data. If the radio conditions are excellent (e.g., signal level is above a threshold), the priority of the chosen bearer may be less important because the WTRU can send more data per a given granted uplink radio resource (e.g., by using the highest modulation and coding scheme).

The threshold(s) associated with the radio conditions that the WTRU uses to determine the radio bearer to use for sending AI/ML data may be specified in terms of retransmission (e.g., at a medium access control (MAC) and/or radio link control (RLC) level).

A WTRU may select/determine a radio bearer to use based on the payload size.

A set of different thresholds for file sizes may be defined/configured in the WTRU (e.g., by the gNB or network). Such thresholds may be configured by the WTRU vendor and/or validated by the gNB or network. A set of thresholds may be defined to categorize file sizes (e.g., uplink data in the WTRU buffer) into a ‘small’, ‘medium’ and ‘large’ type. In one example, a ‘small’ file size may refer to an uplink payload less than 32 bits. A ‘medium’ file size may refer to an uplink payload between 32 bits and 512 bits. A ‘large’ file size may refer to an uplink payload larger than 512 bits.

The WTRU may be configured with rules such that small file sizes may be configured with SRBs; medium file sizes may be configured with, for example, SRB4 or any other existing or new SRB or a DRB; and large file sizes may be configured with, for example, SRB4 or any other existing or new SRB or a DRB.

The WTRU may be configured with rules/thresholds corresponding to two (e.g., only two) size categories (e.g., ‘small’ data size and ‘large’ data size). The WTRU may be configured with a set of rules/thresholds corresponding to more than three size categories (e.g., ‘very small file size’, ‘small file size’, ‘medium file size’, ‘large file size’, ‘very large file size’, etc.).

Different thresholds for file sizes may be defined/configured in the WTRU (e.g., by the gNB/NW) to assist the WTRU in determining the most appropriate radio bearer to use for sending uplink data. The WTRU may be configured with rules to determine the most appropriate radio bearer to use. For example, the WTRU may determine the radio bearer to use based on the type of data to be sent in the UL, radio bearer condition, the destination of the AI/ML server, radio bearer congestion, etc. For example, the WTRU may select a first radio bearer if a payload size of the data is above a threshold. The WTRU may select a second radio bearer if the payload size of the data is below the threshold.

A WTRU may decide the radio bearer to use to send the AI/ML-related data based on the reliability requirements of payload.

A radio bearer (e.g., any radio bearer) that fulfills the conditions associated with the remaining time for sending the AI/ML data, the buffer levels, the size of the data to be sent, and/or radio conditions may be used. DRBs may have different reliability associated with them. For example, some bearers may be configured to use an acknowledged mode RLC (RLC-AM) with retransmissions at the RLC level, thereby providing more reliability. Some radio bearers (e.g., other radio bearers) may be configured to use a transparent mode (e.g., RLC-TM) or an unacknowledged mode (e.g., RLC-UM) that provide no retransmissions.

The choice of the radio bearer to be used may be based on the reliability requirements of the AI/ML data. For example, the WTRU may select, as the radio bearer (e.g., of a selected radio bearer type), a first radio bearer (e.g., of the selected radio bearer type) if a reliability or security standard of the data is above a threshold. The WTRU may select, as the radio bearer (e.g., of the selected radio bearer type), a second radio bearer (e.g., of the selected radio bearer type) if the reliability or security standard of the data is below the threshold. For example, the AI/ML data may need to be highly reliable. The WTRU may choose a radio bearer (e.g., only a radio bearer) that is configured/associated with an acknowledged mode (e.g., RLC-AM). In some examples, the AI/ML data may not need to be highly reliable. In this case, any of the radio bearers may be candidates for sending the AI/ML data.

The WTRU may select/determine a radio bearer to use based on type of payload. For example, the WTRU may select a first radio bearer if a type of the payload of the data is a first payload type. The WTRU may select a second radio bearer if the type of the payload of the data is a second payload type.

A set of different thresholds for file types may be defined/configured in the WTRU (e.g., by the gNB/network) such that some types of data can be sent (e.g., only be sent) via some types of radio bearers. For example, the WTRU may be configured to use one radio bearer (e.g., SRB) for one type of AI/ML traffic (e.g., training metadata) and another radio bearer (e.g., another SRB or DRB) for another type of AI/ML traffic (e.g., training results with all possibilities, training data sets, training configuration, etc.).

The WTRU may select/determine a radio bearer to use based on security/integrity.

A radio bearer (e.g., any radio bearer) that fulfills the conditions associated with the remaining time for sending the AI/ML data, the buffer levels, the size of the data to be sent, and/or radio conditions may be used. DRBs may be configured with or without integrity protection. SRBs may be (e.g., may always be) integrity protected. Some DRBs may not be suitable for certain AI/ML related data (e.g., if the integrity of the AI/ML data is important).

The choice of the radio bearer to be used may be based on the integrity standards of the AI/ML data. For example, the AI/ML data may be (e.g., may need to be) integrity protected. In this case, the WTRU may choose SRBs or DRBs (e.g., only SRBs or DRBs) with integrity protection configured. In some examples, the AI/ML data integrity may not be important. In this case, any of the radio bearers may be candidates for sending the AI/ML data.

A WTRU may select/determine more than one radio bearer for sending control messages/data. A WTRU may use more than one radio bearer for sending control messages and/or AI/ML data. The WTRU may use more than one SRB to send control messages related to AI/ML traffic. For example, the WTRU may use SRB4 to report some application layer measurement reporting information (e.g., on the AI/ML model training metadata). The WTRU may use another SRB (e.g., new SRB) to report the training results.

The WTRU may split the AI/ML traffic between more than one SRB based on the importance/priority of the data. For example, the WTRU may select a radio bearer (e.g., of the selected radio bearer type) to use to send at least a portion of the data (e.g., a first portion of the data) The WTRU may select a second radio bearer (e.g., of the selected radio bearer type). The WTRU may send a second portion of the data via the second radio bearer (e.g., of the selected radio bearer type). For example, higher priority/more important data may be sent in the uplink via SRB1. A lower priority/less important data may be sent in the uplink via SRB2.

The WTRU may use multiple DRBs with different priorities. For example, the WTRU may send training results via a low-priority DRB if an application client (AC) running at the WTRU has finished its model training sooner than expected. The WTRU may send its training hyperparameters with a high-priority radio bearer.

A WTRU may select/determine a radio bearer to use based on a combination of one or more of the aforementioned parameters. The WTRU may be configured to determine the radio bearer to use based on a combination of one or more parameters. For example, the WTRU may determine to use SRB if the uplink data in the WTRU buffer is ‘small’ (e.g., below a preconfigured threshold) and the data is to be sent within strict latency requirements (e.g., within a preconfigured time window). In an example, the WTRU may determine to use DRB if the uplink data in the WTRU buffer is ‘large’ (e.g., above a preconfigured threshold) and the latency bounds to send the data are larger than a threshold.

In some examples (e.g., in which SRBs are used to transmit user plane data) the WTRU may add (e.g., need to add) a marking to the SRB to indicate its usage for user plane data. In some example (e.g., in which SRBs are used to transmit user plane data) there may be a common understanding between the WTRU and the gNB that user plane data (e.g., any user plane data) fulfilling some requirements (e.g., small size and strict latency requirements) can be sent using SRBs (e.g., such that no explicit indication from the WTRU may be needed). The WTRU may send a separate message to the gNB to indicate that the SRBs sent within the next time window will carry user plane data.

Conditions for determining the bearer to use to send the AI/ML data (e.g., such as the radio conditions and buffer levels) may be the current conditions. The WTRU may be capable of predicting the buffer levels and/or radio conditions (e.g., using an already trained AI/ML model, or predicted values provided by the network). The thresholds associated with the buffer levels or radio conditions may consider the current conditions and/or the predicted conditions. For example, the buffer threshold level may be the predicted buffer threshold level within a given time; the WTRU may be configured with threshold values concerning the current buffer level, and threshold values (e.g., other threshold values) concerning the predicted threshold levels; and/or similar considerations may be made for the thresholds related to radio signal levels.

The WTRU may be configured with SRBs dedicated for mapping AI/ML QoS flows. The WTRU may be configured with SRBs applicable for mapping AI/ML QoS flows. The WTRU may be configured with relative priority between different SRBs applicable for AI/ML QoS flows. The WTRU may be configured to determine a first set of SRBs that are currently configured and active (e.g., not suspended). The WTRU may be configured to map the AI/ML QoS flows to the highest priority SRBs within the first set of SRBs.

The WTRU may be configured with DRBs dedicated for mapping AI/ML QoS flows. The WTRU may be configured with DRBs applicable for mapping AI/ML QoS flows. The WTRU may be configured with relative priority between different DRBs applicable for AI/ML QoS flows. The WTRU may be configured to determine a second set of DRBs that are currently configured and active (e.g., not suspended). The WTRU may be configured to map the AI/ML QoS flows to the highest priority DRBs within the second set of DRBs.

The WTRU may be configured with relative priority between a first set of radio bearers (e.g., SRBs) and second set of radio bearers (e.g., DRBs). The WTRU may be configured to determine priority of a first set and a second set of radio bearers as a function of the size of PDU, type of QoS flow (e.g., transmission of AI/ML model, transmission of dataset etc.), type of wireless function associated with AI/ML model (e.g., channel state information (CSI) feedback, beam management, positioning, mobility etc.), buffer status associated with AI/ML QoS flows/radio bearers, and/or the like.

The WTRU may determine the radio bearer mapping for AI/ML QoS flow based on a condition (e.g., an implicit condition). For example, the WTRU may receive a model from the network for training on a radio bearer type (e.g., SRB or DRB). The WTRU may train the model (e.g., locally) based on measurements. Upon training completion, the WTRU may transfer the trained model on the same radio bearer type on which the model was received. Similar implicit mapping may be applied based on an association between downlink radio bearer(s) on which the configuration is received from network and the uplink radio bearer(s) on which the AI/ML flow should be transmitted by the WTRU. Such association may be preconfigured or predefined.

The WTRU may use the control plane (e.g., NAS signaling over SRB2) to upload its training results to the AI/ML function hosted in the 5GC. This AI/ML function may be an instance of NWDAF (Network Data Analytics Function) of 5GC. The NWDAF may provide data and analytics services to network functions (e.g., other network functions in 5GC) and/or to other entities in the 3GPP system (e.g., WTRU and/or RAN). An example NWDAF may use an ML technique to produce its results.

The WTRU may use SRB0, SRB1, or another (e.g., new) SRB to transmit training results to the AI/ML server hosted in the gNB over an uplink RRC message (e.g., a new uplink RRC message for transmitting user plane data). The WTRU may use NAS message within SRB1 to transmit AI/ML data to the AI/ML server hosted in gNB.

The WTRU may be configured to use an SRB to initially transmit training results to a gNB and from the gNB to the AI/ML server (e.g., hosted in a cloud) via UPF of 5GC. The AI/ML server may be hosted outside/inside the 3GPP network. The WTRU may be configured to use (e.g., only use) DRBs to send/receive data to/from the network.

The WTRU may map a QoS flow to a high/low priority bearer (e.g., depending on the priority of AI/ML data). For example, if SRBs are intended to be used, SRB1 may have higher priority than SRB2. For example, if DRBs are intended to be used, one DRB may have higher priority than the others. Some factors (e.g., other factors) may be considered by the WTRU apart from location of the AI/ML server to determine which SRBs or DRBs to use for a particular QoS flow.

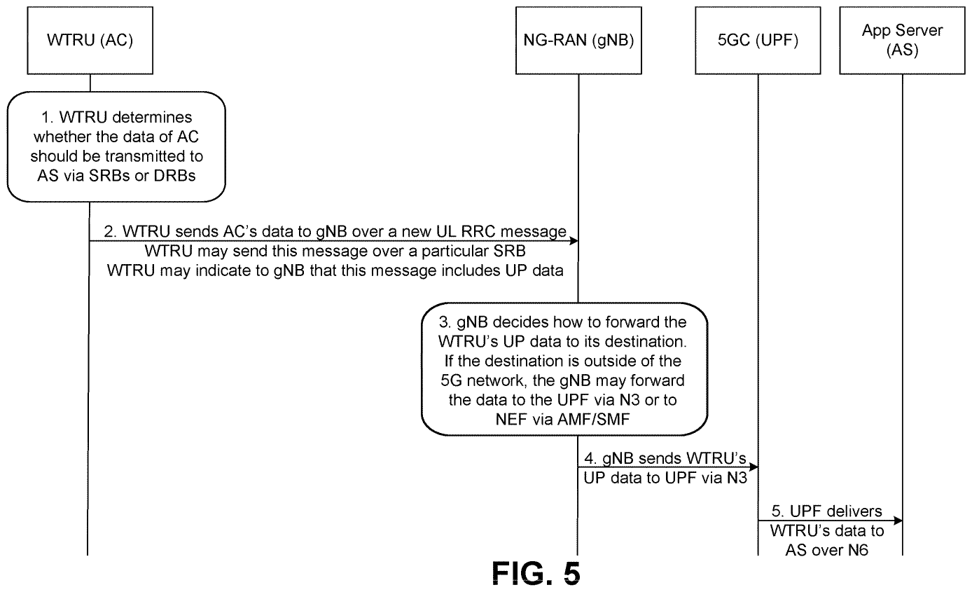

FIG. 5 is an example illustrating a WTRU selecting/determining whether to use the control plane or the user plane, and over which radio bearers to send data. The WTRU's determination may allow the AI/ML AC (e.g., running at WTRU) to transmit the data with a certain (e.g., required) transmission priority.

At 1, the WTRU may determine how to transmit the AC's data to the network. The WTRU may decide whether the AC's data should be transmitted via CP or UP. The WTRU may decide over which SRBs or DRBs the AC's data should be transmitted. The WTRU may be configured with a policy to assist in this decision-making. The policy may consider several parameters. For example, the parameters may include data size, the priority of data, radio condition of SRBs/DRBs, current QoS flow rules, the destination of AI/ML server (e.g., AS), user mobility, and/or the like.

At 2, the WTRU may send the AC's data (e.g., AI/ML training results) to a gNB (e.g., via an uplink RRC message). The WTRU may send the data via a particular SRB (e.g., depending on the priority of the uplink data transmission). The WTRU may indicate to the gNB whether this message includes the WTRU's user plane data (e.g., that the gNB will forward to its destination). The destination of the data may be in gNB/RAN or elsewhere. If the AS is hosted in a cloud data center outside of the 5G network, the gNB may forward the WTRU's data to the AS via UPF over N3 or via network exposure function (NEF) via AMF/SMF.

At 3, the gNB may forward the WTRU's data to the AS (e.g., via the UPF). The data transmission between the gNB and the UPF may be via N3 tunnel. The WTRU's data may be delivered from the UPF to the AS over N6.

FIG. 6 illustrates an example timeline for data transmission. One or more WTRU(s) may be configured to perform an AI/ML related action (e.g., AI/ML training). The WTRU(s) may send a report (e.g., trained model weights) within a given time (e.g., before a deadline).

In the example of FIG. 6, a first WTRU (e.g., WTRU1) may finish the training ahead of the deadline. In this case, the first WTRU may send the results on time (e.g., even if the first WTRU was configured to use a low priority RB, for example, a DRB). A second WTRU (e.g., WTRU2) may finish the training closer to the deadline. In this case, the second WTRU may send the results on time if (e.g., only if) the second WTRU was configured to use a high priority RB (e.g., a high priority DRB or SRB). The network and/or the WTRUs may not know when the action (e.g., training) will be completed (e.g., since that may depend on variable WTRU and/or network conditions).

FIG. 7 is an example call flow illustrating a WTRU selecting/determining a radio bearer over which to send data. As illustrated, a network node may send configuration information to a WTRU. The configuration information may include specifications (e.g., requirements) for data (e.g., AI/ML related data). The configuration information may include RBs (e.g., DRBs and/or SRBs) that the WTRU may use for sending the data. The configuration information may include one or more conditions (e.g., UL buffer level, radio conditions, etc.). The WTRU may use the condition(s) to determine which RB(s) to use to send the data.

The network node may send an indication of one or more triggers that indicate for the WTRU to start AI/ML related action(s) (e.g., training). The network node may send information regarding a deadline for sending results of the action(s), quality of service (QoS) specifications (e.g., requirements) such as security and reliability specifications, and/or the like.

The WTRU may start performing the AI/ML related action(s) (e.g., in response to a trigger). The WTRU may complete the action(s) to generate the results/data. The WTRU may determine the RB(s) to use to send the data according to specifications (e.g., requirements) of the data. For example, the WTRU may determine the RB(s) to use to send the data based on the size of the data, a security and/or reliability specification of the data, and/or the like. The WTRU may determine the RB(s) to use to send the data according to WTRU conditions (e.g., current uplink buffer level, etc.), network conditions (e.g., radio conditions, etc.), the configuration information received from the network node, and/or the like. The WTRU may send the data to the network node using the selected/chosen RB(s).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-18. (canceled)

19. A wireless transmit/receive unit (WTRU) comprising:
a processor configured to:
receive information that indicates:
a first radio bearer configuration that indicates a radio bearer of a first radio bearer type associated with a control plane;
a second radio bearer configuration that indicates a radio bearer of a second radio bearer type associated with a user plane;
a condition associated with sending data associated with an artificial intelligence/machine learning (AI/ML)-related operation;
a first association between the condition and the first radio bearer type, and a second association between the condition and the second radio bearer type;
receive an indication to start the AI/ML-related operation;
determine that the data associated with the AI/ML-related operation is available;
select, based on at least the condition, a radio bearer type, from the first radio bearer type and the second radio bearer type, to use to send the data; and
send at least a portion of the data via a radio bearer of the selected radio bearer type.

20. The WTRU of claim 19, wherein the first radio bearer type comprises a signaling radio bearer (SRB), and wherein the second radio bearer type comprises a data radio bearer (DRB).

21. The WTRU of claim 19, wherein the AI/ML-related operation comprises training an AI/ML model, and wherein the processor is further configured to:
receive an indication of a time to start training the AI/ML model and a deadline by which to send the data, and wherein the data indicates at least one of: that the AI/ML model is trained or a parameter associated with the training;
determine a first estimated send time of the data based on the first association and a second estimated send time of the data based on the second association, wherein the processor being configured to select, based on at least the condition, the radio bearer type, from the first radio bearer type and the second radio bearer type, to use to send the data comprises the processor being configured to select the radio bearer type based on whether one or more of the first estimated send time or the second estimated send time satisfies a deadline threshold; and
at the time to start training the AI/ML model, perform AI/ML training, wherein the at least a portion of the data is sent in accordance with the deadline threshold.

22. The WTRU of claim 19, wherein the AI/ML-related operation comprises collecting the data, and wherein the processor being configured to send at least a portion of the data via a radio bearer of the selected radio bearer type comprises the processor being configured to send the data to a network entity for training an AI/ML model.

23. The WTRU of claim 19, wherein the processor is further configured to select the radio bearer of the selected radio bearer type, from a first and a second radio bearer of the selected radio bearer type, based on an uplink buffer level, and wherein the processor being configured to select the radio bearer of the selected radio bearer type based on the uplink buffer level comprises the processor being configured to:
select the first radio bearer if a total uplink buffer level of the first radio bearer and the second radio bearer is above a threshold, and
select the second radio bearer if the total uplink buffer level of the first radio bearer and the second radio bearer is below the threshold; or
select the first radio bearer if an uplink buffer level of the first radio bearer is below an uplink buffer level of the second radio bearer, and
select the second radio bearer if the uplink buffer level of the second radio bearer is below the uplink buffer level of the first radio bearer.

24. The WTRU of claim 19, wherein the processor is further configured to:
select, as the radio bearer of the selected radio bearer type, a first radio bearer of the selected radio bearer type if a radio condition of a serving cell is above a threshold; and
select, as the radio bearer of the selected radio bearer type, a second radio bearer of the selected radio bearer type if the radio condition of the serving cell is below the threshold.

25. The WTRU of claim 19, wherein the processor is further configured to select the radio bearer of the selected radio bearer type, from a first and a second radio bearer of the selected radio bearer type, based on a payload of the data, and wherein the processor being configured to select the radio bearer of the selected radio bearer type based on the payload of the data comprises the processor being configured to:
select the first radio bearer if a payload size of the data is above a threshold, and
select the second radio bearer if the payload size of the data is below the threshold; or
select the first radio bearer if a type of the payload of the data is a first payload type, and
select the second radio bearer if the type of the payload of the data is a second payload type.

26. The WTRU of claim 19, wherein the processor is further configured to:
select, as the radio bearer of the selected radio bearer type, a first radio bearer of the selected radio bearer type if a reliability or security standard of the data is above a threshold; and
select, as the radio bearer of the selected radio bearer type, a second radio bearer of the selected radio bearer type if the reliability or security standard of the data is below the threshold.

27. The WTRU of claim 19, wherein the radio bearer of the selected radio bearer type is a first radio bearer of the selected radio bearer type, the at least a portion of the data is a first portion of the data, and the processor is further configured to:
select a second radio bearer of the selected radio bearer type; and
send with a second portion of the data via the second radio bearer of the selected radio bearer type.

28. A method performed by a wireless transmit/receive unit (WTRU), the method comprising:
receiving information that indicates:
a first radio bearer configuration that indicates a first radio bearer of a first radio bearer type associated with a control plane;
a second radio bearer configuration that indicates a second radio bearer of a second radio bearer type associated with a user plane;
a condition associated with sending data associated with an artificial intelligence/machine learning (AI/ML)-related operation;
a first association between the condition and the first radio bearer type, and a second association between the condition and the second radio bearer type;
receiving an indication to start the AI/ML-related operation;
determining that the data associated with the AI/ML-related operation is available;
selecting, based on at least the condition associated with sending the data, a radio bearer type, from the first radio bearer type and the second radio bearer type, to use to send the data; and
sending at least a portion of the data via a radio bearer of the selected radio bearer type.

29. The method of claim 28, wherein the first radio bearer type comprises a signaling radio bearer (SRB), and wherein the second radio bearer type comprises a data radio bearer (DRB).

30. The method of claim 28, wherein the method further comprises:
receiving an indication of a time to start training an AI model and a deadline by which to send the data, and wherein the data indicates at least one of: that the AI model is trained or a parameter associated with the training; and
at the time to start training the AI model, performing AI training, wherein the at least a portion of the data is sent in accordance with the deadline threshold.

31. The WTRU of claim 28, wherein the AI/ML-related operation comprises collecting the data, and wherein sending at least a portion of the data via a radio bearer of the selected radio bearer type comprises sending the data to a network entity for training an AI/ML model.

32. The method of claim 28, wherein the method further comprises selecting the radio bearer of the selected radio bearer type, from a first and a second radio bearer of the selected radio bearer type, based on an uplink buffer level, and wherein selecting the radio bearer of the selected radio bearer type based on the uplink buffer level comprises:
selecting the first radio bearer if a total uplink buffer level of the first radio bearer and the second radio bearer is above a threshold, and
selecting the second radio bearer if the total uplink buffer level of the first radio bearer and the second radio bearer is below the threshold; or
selecting the first radio bearer if an uplink buffer level of the first radio bearer is below an uplink buffer level of the second radio bearer, and
selecting the second radio bearer if the uplink buffer level of the second radio bearer is below the uplink buffer level of the first radio bearer.

33. The method of claim 28, wherein the method further comprises:
selecting, as the radio bearer of the selected radio bearer type, a first radio bearer of the selected radio bearer type if a radio condition of a serving cell is above a threshold; and
selecting, as the radio bearer of the selected radio bearer type, a second radio bearer of the selected radio bearer type if the radio condition of the serving cell is below the threshold.

34. The method of claim 28, wherein the method further comprises selecting the radio bearer of the selected radio bearer type, from a first and a second radio bearer of the selected radio bearer type, based on a payload of the data, and wherein selecting the radio bearer of the selected radio bearer type based on the payload of the data comprises:
selecting the first radio bearer if a payload size of the data is above a threshold, and
selecting the second radio bearer if the payload size of the data is below the threshold; or
selecting the first radio bearer if a type of the payload of the data is a first payload type, and
selecting the second radio bearer if the type of the payload of the data is a second payload type.

35. The method of claim 28, wherein the method further comprises:
selecting, as the radio bearer of the selected radio bearer type, a first radio bearer of the selected radio bearer type if a reliability or security standard of the data is above a threshold; and
selecting, as the radio bearer of the selected radio bearer type, a second radio bearer of the selected radio bearer type if the reliability or security standard of the data is below the threshold.

36. The method of claim 28, wherein the radio bearer of the selected radio bearer type is a first radio bearer of the selected radio bearer type, the at least a portion of the data is a first portion of the data, and the method further comprises:
selecting a second radio bearer of the selected radio bearer type; and
sending with a second portion of the data via the second radio bearer of the selected radio bearer type.
